(19) United States
(12) Patent Application Publication
(10) Pub. No.: US 2014/0298286 A1
(43) Pub. Date: Oct. 2, 2014

(54) Systems and Methods for Automatically Associating Software Elements and Automatic Gantt Chart Creation

(71) Applicant: Massively Parallel Technologies, Inc., Boulder, CO (US)

(72) Inventor: Kevin D. Howard, Tempe, AZ (US)

(21) Appl. No.: 14/306,126

(22) Filed: Jun. 16, 2014

Related U.S. Application Data
(63) Continuation-in-part of application No. 13/425,136, filed on Mar. 20, 2012.
Application No. 13/425,136 is a continuation-in-part of application No. 13/490,345, filed on Jun. 6, 2012, now Pat. No. 8,762,946.
(60) Provisional application No. 61/835,477, filed on Jun. 14, 2013.
(60) Provisional application No. 61/841,004, filed on Jun. 28, 2013.

(51) Int. Cl. G06F 9/44

(52) U.S. Cl. CPC G06F 8/20
USPC 717/101; 717/104

(57) ABSTRACT

A system, method and software product automatically associates a software code block with a design element of a software design. Within a development server, a list of code blocks that have a first set of keywords matching a second set of keywords of the design element is generated. A test procedure is used to test each of the remaining code blocks in the list to determine whether the code block generates correct results. Code blocks that do not generate correct results are removed from the list. One code block that best matches developer goals of the software design is selected from the list and associated with the design element. The system and method may additionally automatically create a Gantt chart of the software design.

### RELATED APPLICATIONS

This application is a continuation-in-part of and claims the benefit of priority to U.S. patent application Ser. No. 13/425,136, filed Mar. 20, 2012, entitled “Parallelism from Functional Decomposition”. This application further claims the benefit of priority to U.S. patent application Ser. No. 13/490,345, filed Jun. 6, 2012 entitled “Method for Automatic Extraction of Designs from Standard Source Code”; U.S. Provisional Patent Application Ser. No. 61/835,477, filed Jun. 14, 2013 and entitled “System and Method for Automatically Associating Software Components”; and U.S. Provisional Patent Application Ser. No. 61/841,004, filed Jun. 28, 2013 and entitled “System and Method for Automatically Associating Software Elements”. Each of the aforementioned applications are incorporated herein by reference.

### BACKGROUND

Software code sharing is important, as the current state-of-the-art allows for the sharing of subroutines (sometimes called methods) and libraries of subroutines. The term “subroutine” in computer-science typically refers to a named block of code which may have a parameter list and which may have a return value. This block of code can be accessed from within another code block via the use of its name and parameter list. There can be significant amounts of code within the subroutine. Sharing portions of a subroutine is not possible unless the to-be-shared code portion is itself a subroutine. Rather than requiring the entire subroutine be shared, it is more efficient to share only that portion of the subroutine that is required to be shared.

In prior art software code and software design quickly become disassociated.

In addition to automatic software element association, typically, the creation of a complex software system entails creating and managing a project. The most common project management tools are the Gantt and PERT (Program Evaluation and Review Technique) charts. Microsoft Corporation has shown that a Gantt chart can be converted into a PERT chart and vice versa. These charts are composed of tasks, time durations for each task, task dependencies, and starting dates for each task. The various tasks and their associated attributes are currently manually entered and manually maintained. This is because the current project management tools are general tools which are separate from software design.

### SUMMARY OF THE INVENTION

To maintain code/design and file/database/design association, the code and/or file/database are automatically, versus manually, located in a file, database, library, or cloud. With automatic code-design and file/database-design association, a developer simply designs while code and/or files/databases are located and associated automatically. Contrast this with source-code sharing models that require the developer to first find then analyze and finally associate blocks of code or locate and verify files and databases. Once code/files/databases and design are reliably associated then new, better code/files/databases may also be automatically located to replace existing code blocks, effectively allowing automatic code/file/database upgrading.

In one embodiment, a system for automatically associating a software code block with a design element of a software design, includes: a processor; a memory communicatively coupled with the processor storing: the software design having the design element, the design element having (i) a list of keywords and (ii) test procedures associated therewith; and an associator stored within the memory as non-transitory computer readable instructions that when executed by the processor associate the software code block with the design element.

In another aspect, a method for automatic Gantt chart creation of a software design having a plurality of elements, includes: receiving, at a project manager comprising non-transitory computer readable medium stored on memory communicatively coupled to a processor of a software development system, completion information of the elements of the software design; generating completion date information based upon a date that code blocks are assigned to each of the elements; and generating a visual representation of a Gantt chart including the completion information and the completion date information.

### BRIEF DESCRIPTION OF THE FIGURES

FIG. 1 shows one exemplary parallel processing development system for automatically associating software elements, in an embodiment.

FIG. 2 is a flowchart illustrating one exemplary method for automatically associating a code block with a design element of a software design, in an embodiment.

FIG. 3 shows one exemplary user interface screen of the system of FIG. 1, illustrating association of code blocks with a software element of the software design, in an embodiment.

FIG. 4 shows one exemplary user interface screen of the system of FIG. 1, illustrating association of metadata with a transformation process (green bubble), in an embodiment.

FIG. 5 shows one exemplary keyword popup that is displayed upon selection of the “Add Keyword List” option, in an embodiment.

FIG. 6 shows a first step of performing a keyword search to generate a possible code block list based upon keywords associated with a transform process, in an embodiment.

FIG. 7 shows an exemplary second step where inputs, outputs, and loops are matched for each code block within list of FIG. 6, in an embodiment.

FIG. 8 shows an exemplary test procedure table that is displayed after an “Add Test Plans/Procedure” button is selected, in an embodiment.

FIG. 9 shows one exemplary third step illustrating execution of test procedures against each code block, in an embodiment.

FIG. 10 shows one exemplary table listing possible goals for selection by the designer, in an embodiment.

FIG. 11 shows a final step for selection of the code block based upon the goals selected from the table of FIG. 10, in an embodiment.

FIG. 12 shows the memory of FIG. 1 in further exemplary detail illustrating data structures used by the associator to automatically attach a file/database to a data store of the software design, in an embodiment.

FIG. 13 shows exemplary F-type data store symbol that may be used within the software design of FIG. 1 to represent file access and that allows files and databases to be attached to high level design process elements, in an embodiment.

FIG. 14 shows one exemplary file definition list that is displayed when a developer right-clicks on the F-type symbol of FIG. 13 within the software design of FIG. 1, in an embodiment.

FIG. 15 shows one exemplary file format table that is used to define the access method of the data store, and includes a filename, a file description, a keyword list, and a list of fields within the file, in an embodiment.

FIG. 16 shows one exemplary database information description that is displayed when the database button of FIG. 14 is selected, in an embodiment.

FIG. 17 shows one exemplary list of supported database types that is displayed when the database type button of FIG. 16 is selected, in an embodiment.

FIG. 18 shows one exemplary schema created by the developer by selecting the schema button to define the current database, in an embodiment.

FIG. 19 shows one exemplary query entry screen that is displayed when the developer selects the queries button of database information description of FIG. 16, in an embodiment.

FIG. 20 shows one exemplary screen for defining a set of test queries that is attached to a database to allow that database to be tested for correctness, in an embodiment.

FIG. 21 shows one exemplary screen for defining file “queries”, in an embodiment.

FIG. 22 shows a first step of generating a file or database list based upon keywords of the F-type data store identified by the developer selecting F-type data store symbol of FIG. 13 within the software design of FIG. 1, in an embodiment.

FIG. 23 shows one exemplary second step for culling the file or database list of FIG. 22 by comparing the F-Type Data Access Method and the defined Data Access Methods of each file or database, in an embodiment.

FIG. 24 shows a third exemplary step for further culling the list of FIG. 22 by executing test queries attached to a database against each remaining files/databases within the list, in an embodiment.

FIG. 25 is a flowchart illustrating one exemplary method for automatically associating a file/database with a design element of a software design, in an embodiment.

FIG. 26 shows an exemplary parallel processing development system for automatic Gantt chart creation, in one embodiment.

FIG. 27 depicts an exemplary hierarchical software design, in one embodiment.

FIG. 28 depicts an exemplary two process design showing conditional statements, and completion information thereof, in one embodiment.

FIG. 29 depicts an exemplary Gantt chart, of the process of FIG. 28, created by the project manager of FIG. 26, in one embodiment.

FIG. 30 depicts an exemplary Gantt chart, that is similar to the Gantt chart of FIG. 29, but further includes assignee information.

FIG. 31 depicts an exemplary screen shot of a visual representation including a critical path indicator, in one embodiment.

FIG. 32 depicts a visual representation of a Gantt chart of FIG. 26 further illustrating the critical path information of FIG. 26.

FIG. 33 depicts an exemplary Gantt chart including completion percentage data of FIG. 26.

FIG. 34 depicts a method for automatic Gantt chart creation, in one embodiment.

### DETAILED DESCRIPTION OF THE EMBODIMENTS

### Metadata

Metadata is information about a thing rather than the thing itself. For automatic code search/test/design association the required code metadata is a keyword list for each block of code and a list of all inputs and outputs to/from the code block. Similarly each decomposition design element (process bubble) must also have an associated keyword list, input/output list (from the design), and test procedures.

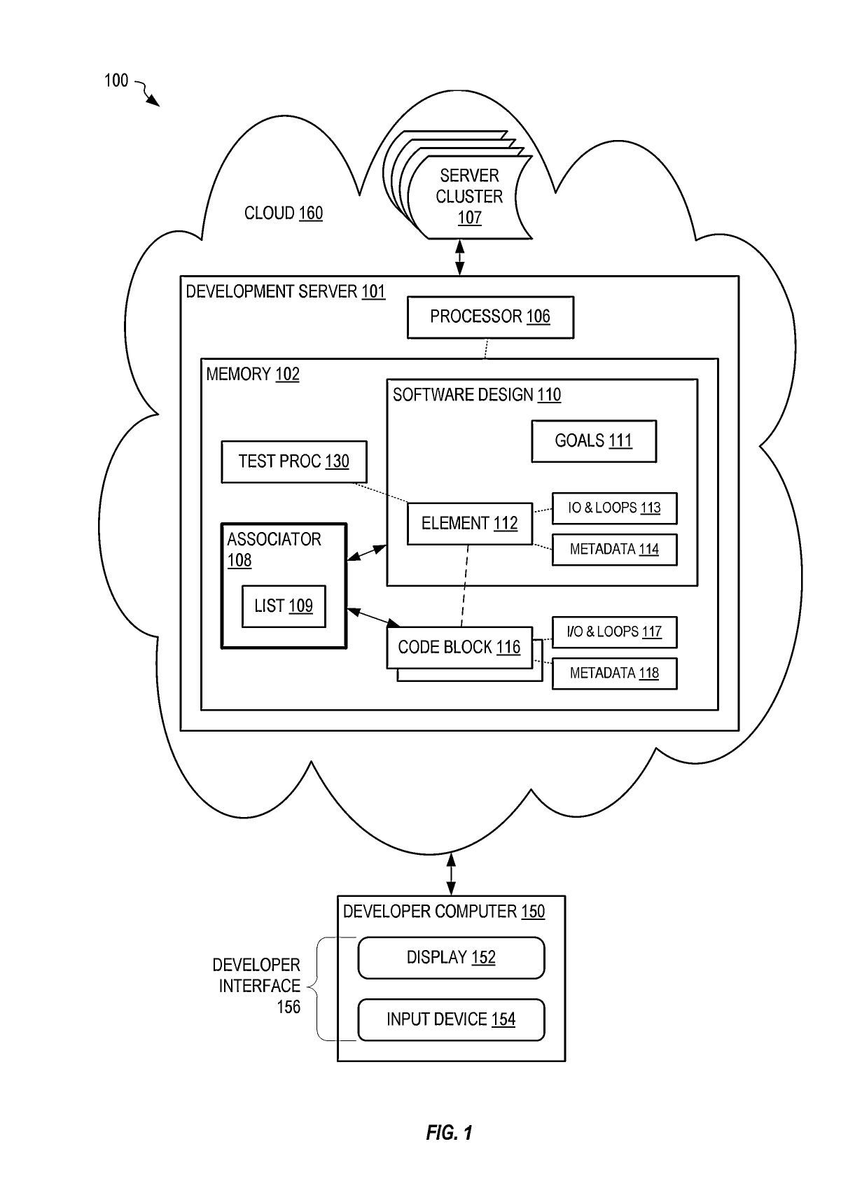

FIG. 1 shows one exemplary parallel processing development system 100 for automatically associating software elements. System 100 includes a development server 101 that is located within cloud 160 (e.g., a computer network accessible via the Internet) and is coupled with, or is a part of, a server cluster 107. Server cluster 107 is for example a plurality of processing nodes configured to operate as a Howard Cascade. Development server 101 is a computer with a processor 106 and a memory 102 that stores a software design 110, a code block 116, and a test procedure 130. Memory 102 is also shown storing an associator 108 formed of machine readable instructions that when executed by processor 106 implement functionality of system 100 as described below.

Software design 110 contains at least one element 112 that has associated input/output and loop information 113 that defines inputs, outputs, and loop structures of element 112. Software design 110 is for example a hierarchical functional decomposition software design as disclosed in U.S. application Ser. No. 13/425,136 (e.g. decomposition of algorithm 117 within application Ser. No. 13/425,136).

Element 112 also has associated metadata 114 that may include a list of keywords that describe element 112. Each element 112 may be one or more of control kernel, process kernel, data transformation, control transformation, control bubble and process bubble as defined in the '136 App. Code block 116 has associated input/output and loop information 113 that defines inputs, outputs, and loop structures of code block 116. Code block 116 also has associated metadata 118 that may include a list of keywords that describe operation of code block 116. Associator 108 operates, using a list 109, to automatically select code block 116 for use within an implementation of software design 110 based upon (a) matching of input/output and loop information 113 with input/output and loop information 113 and (B) matching of metadata 118 with metadata 114.

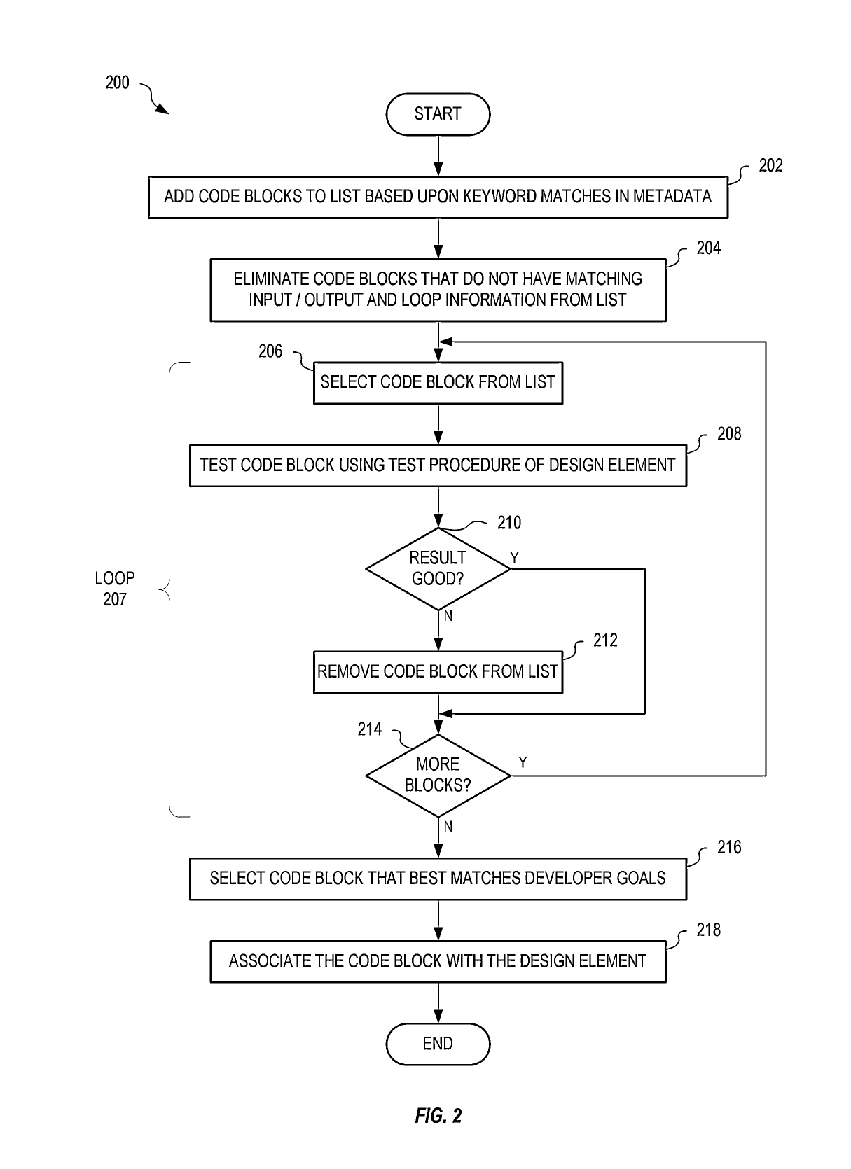

FIG. 2 is a flowchart illustrating one exemplary method 200 for automatically associating a code block with a design element of a software design. Method 200 is for example implemented as machine readable instructions that form at least part of associator 108 of development server 101, FIG. 1.

In step 202, method 200 adds at least one code block to a list based upon keyword matches in metadata. In one example of step 202, associator 108 compares keywords of metadata 118 of each code block 116 with keywords of metadata 114 of element 112 and adds code block 116 to list 109 if the keywords match.

In step 204, method 200 eliminates code blocks that do not have matching input/output and loop information from the list. In one example of step 204, associator 108 compares, for each code block 116 within list 109, input/output and loop information 113 with input/output and loop information 113 of element 112, and remove code blocks from list 109 where input/output and loop information 113 does not match input/output and loop information 113.

Steps 206 through 214 form a loop 207 that repeats for each code block within list 109. In step 206, method 200 selects a first, and subsequently a next, code block from the list. In one example of step 206, associator 108 selects a next code block from list 109.

In step 208, method 200 tests the code block using test procedure of the design element. In one example of step 208, associator 108 uses test procedure 130 to test code block 116 selected in step 206.

Step 210 is a decision. If, in step 210, method 200 determines that the test results are correct, method 200 continues with step 214; otherwise method 200 continues with step 212. In step 212, method 200 removes the code block from the list. In one example of step 212, associator 108 removes code block 116 from list 109 within memory 102.

Step 214 is a decision. If, in step 214, method 200 determines that at least one unprocessed code block is within the list, method 200 continues with step 206 to repeat loop 207; otherwise method 200 continues with step 216.

In step 216, method 200 selects a code block from the list that best matches developer goals. In one example of step 216, associator 108 evaluates each remaining code block 116 within list 109 and selects the code block that matches design goals 111.

In step 218, method 200 associates the code block with the design element. In one example of step 218, associator 108 associates code block 116 with design element 112.

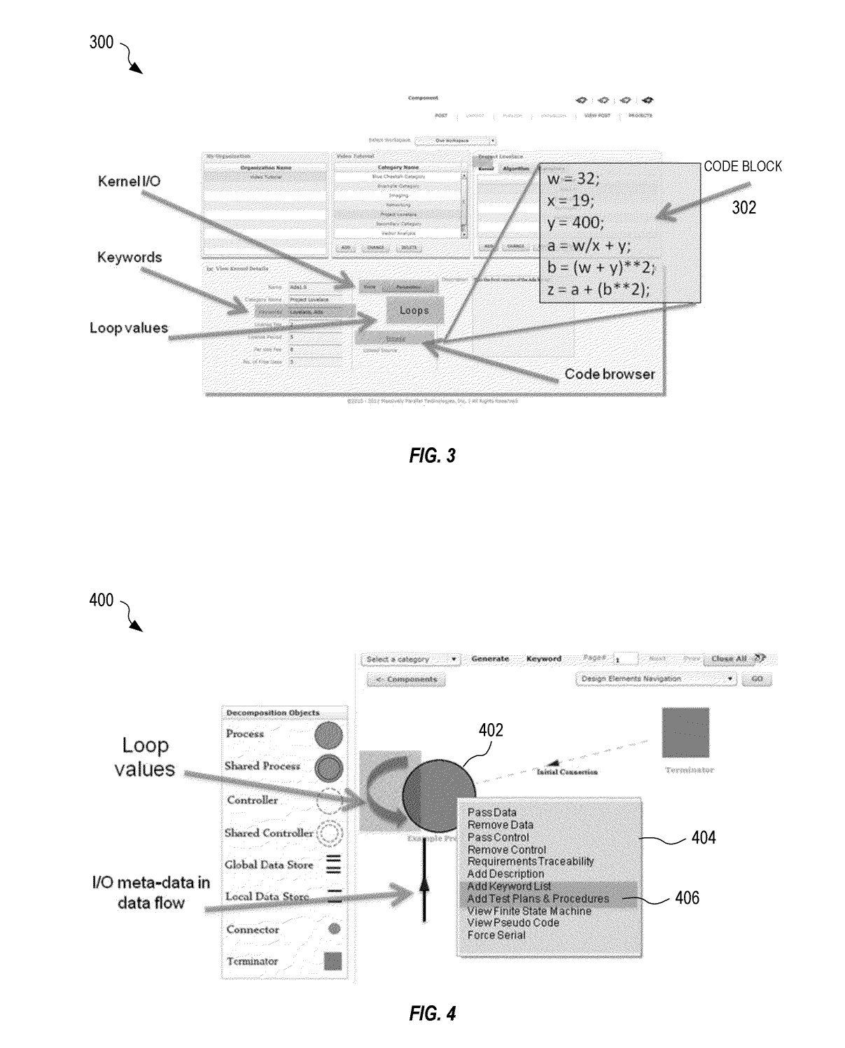

FIG. 3 shows one exemplary user interface screen 300 of system 100, FIG. 1, illustrating association of code blocks 302 with a software element of software design 110. User interface screen 300 is for example displayed on display 152 of developer computer 150. Code blocks 302 are located (e.g., using a browser or some other search method) and attached, within the development environment 100, to metadata that may include: keywords, loops, input/output, description, category, and fees.

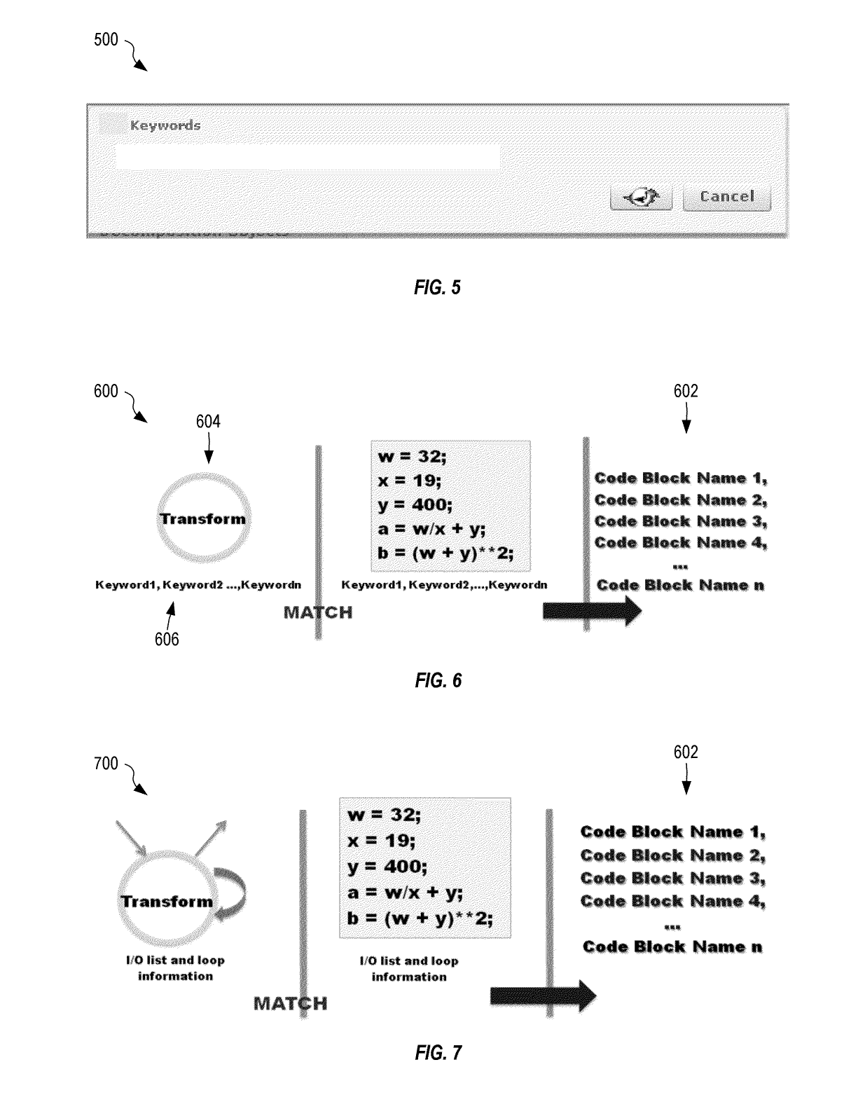

FIG. 4 shows one exemplary user interface screen 400 of system 100, FIG. 1, illustrating association of metadata with a transformation process (bubble) 402. Specifically, user interface screen 400 shows a drop down option box 404 that includes selectable options for associating keywords and test procedures with transformation process 402. For example, selection of the “Add Keyword List” option causes the keyword popup 500 to display, as shown in FIG. 5. Since both code block 116 and transform process 402 may have an associated keyword list, it is possible to create a list of candidate code blocks for any particular transformation process.

FIG. 6 shows an exemplary first step 600 of performing a keyword search to generate a possible code block list 602 based upon keywords 606 associated with a transform process 604. First step 600 is for example similar to step 202 of method 200 of FIG. 2. List 602 is for example a representation of list 109 of FIG. 1. List 602 contains all code blocks that have keywords 606 within associated metadata 118. However, this list is too long, since only one code block name may be assigned to transform process 604.

FIG. 7 shows an exemplary second step 700 where inputs, outputs, and loops are matched for each code block within list 602 of FIG. 6. Step 700 is similar to step 204 of method 200 of FIG. 2. In order to shrink list 602 (i.e., cull it) and also to determine if test procedures may be run against the listed code blocks, the I/O and loops 113 of element 112 are compared with I/O and loops 113 defined for each of the listed code blocks 116. Code blocks that do not have matching I/O and loops are removed from list 602.

Unlike traditional software development systems, system 100 does not associate test procedures 130 with code blocks 116. Rather, system 100 associates test procedures 130 with design element 112 (e.g., a transformation processes) of software design 110. By associating test procedures 130 with design element 112, each code block 116 remaining in list 602 may be evaluated against test procedure 130. Test procedure 130 comprises input data and expected output data, and therefore each code block within list 602 is tested, using the test procedure and input data, to determine whether it generates the correct output data. Code blocks 116 that do not generate the correct output data for test procedure 130 are culled from list 602.

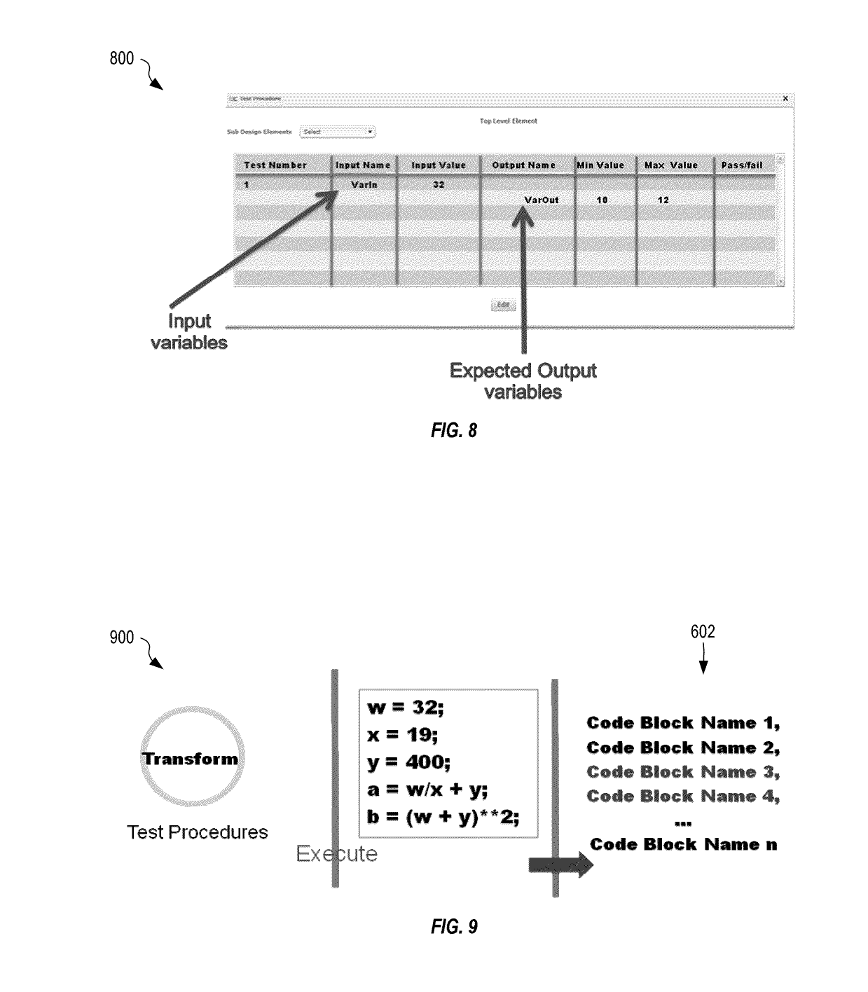

FIG. 8 shows an exemplary test procedure table 800 that is displayed after an “Add Test Plans/Procedure” button 406 is selected Test procedure table 800 illustrates an exemplary test procedure being associated with a transformation process. For example, once the add test plans/procedure button 406 is selected associated with a particular element (i.e. process 402), table 800 is show for the particular element. Table 800 then details all test plans/procedures associated with the particular element.

FIG. 9 shows one exemplary third step 900 illustrating execution of test procedures against each code block 116. Expected values for test procedure 130 are compared to results from execution of code block 116 using input data of the test procedure. Code blocks 116 that do not provide the correct output data are removed from list 602.

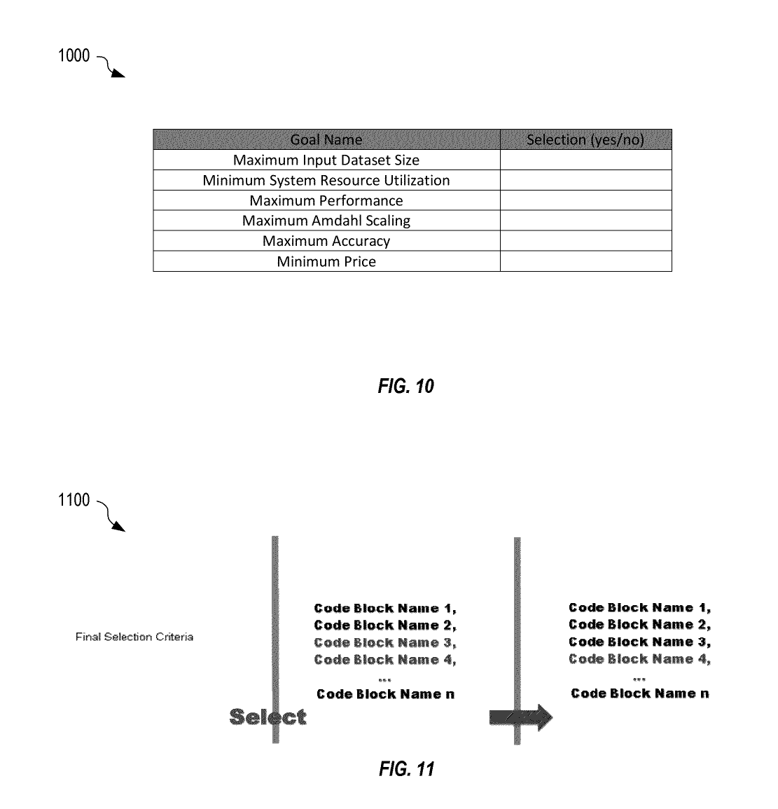

After third step 900, only a few code blocks 116 remain within list 602. One additional step is used to decrease list 602 to one code block: developer goals. A developer of design 110 defines the overall goals 111 they are trying to achieve with design 110. FIG. 10 shows one exemplary table 1000 listing possible goals for selection by the designer. The developer selects one or more of these goals that apply to design 110 and stored them as goals 111 within design 110 for example. The developer may either select one of the goals listed or add their own. One code block within list 602 that best matches these goals 111 is selected for implementation of element 112.

FIG. 11 shows a final step 1100 for selection of code block 116 based upon goals 111 selected from table 1000. The selected code block 115 is thereby automatically associated with element 112 of software design 110. Once code block 116 is automatically associated with design element 112, the code and the design do not drift apart. There are two reasons why a single code block cannot be selected for automatic association with a design element: (a) the code block has not yet been written, or (b) the design is not fully decomposed.

### Data Store Extension

A data store in system 100 is similar to a “C” or “C++” language data structure. That is, software that is designed within system 100 is executed to processes data within these data structure type data stores. Data stores do not directly represent data that is stored within files and databases. That is, files and databases are not directly attached to High Level Design Process Elements (HLD-PEs) within software design 110.

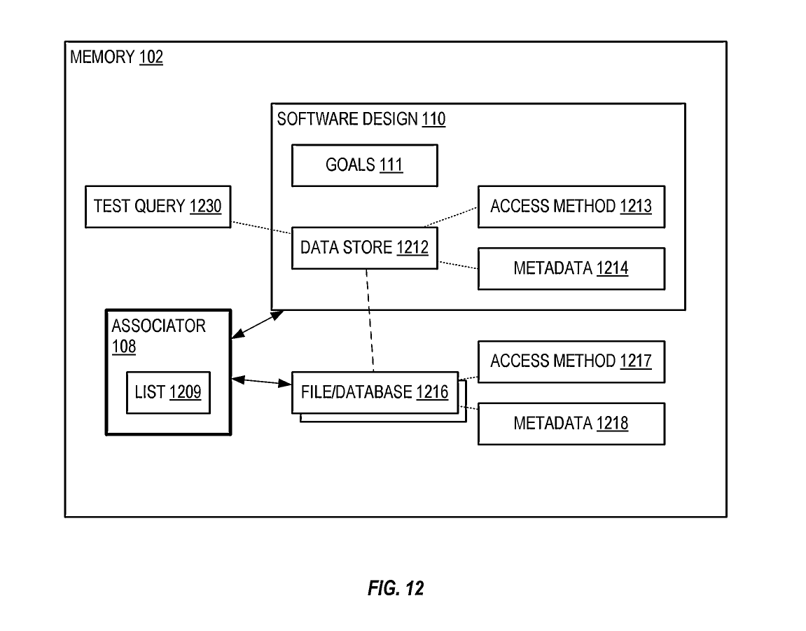

FIG. 12 shows memory 102 of FIG. 1 in further exemplary detail illustrating data structures used by associator 108 to automatically attach a file/database 1216 to a data store 1212 of software design 110.

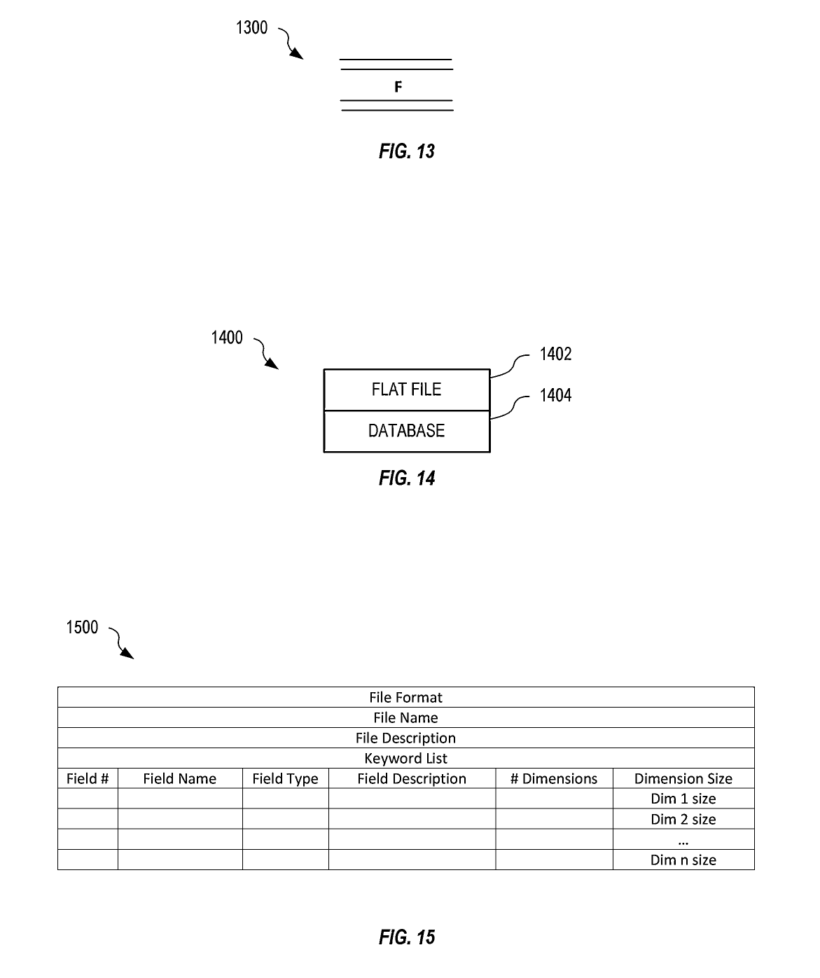

FIG. 13 shows exemplary F-type data store symbol 1300 that may be used within software design 110 of FIG. 1 to represent file access and that allows files and databases to be attached to HLD-PEs. FIG. 14 shows one exemplary file definition list 1400 that is displayed when a developer right-clicks on F-type symbol 1300 within a graphical representation of software design 110 (for example, symbol 1300 may additionally be illustrated in screenshot 400 were a datastore to be associated with process 402). In the example of FIG. 14, the selectable options for F-type data store 1300 are made using a “flat file” button 1402 and “database” button 1404.

### Flat File Selection

FIG. 15 shows one exemplary file format table 1500 that is used to define the access method of the data store, and includes a filename, a file description, a keyword list, and a list of fields within the file. Once table 1500 is defined, system 100 serializes the data from the file as an input dataset and saves the input dataset within cloud 160. This dataset is then usable within any software design by selecting the correct file name with the correct keyword list and field names/types. Within system 100, standard file calls are treated as if they are database queries (see queries).

### Database Selection

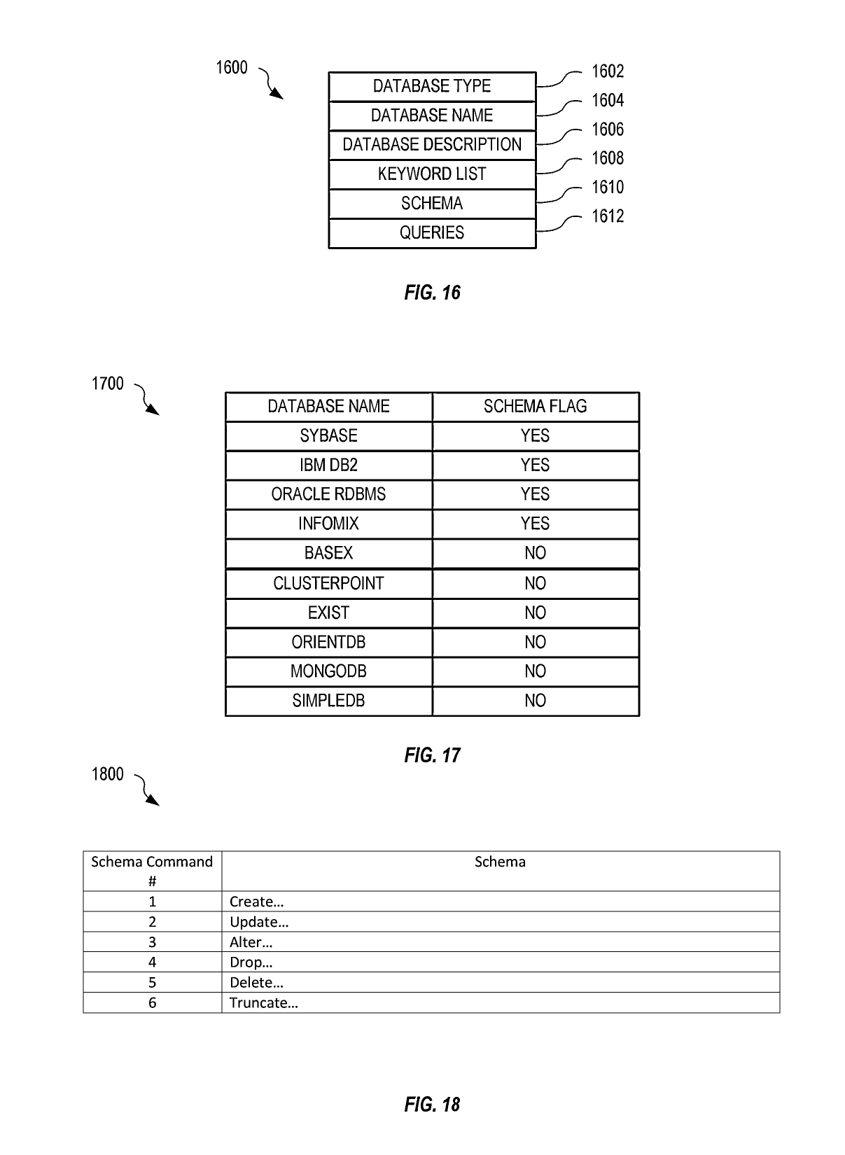

FIG. 16 shows one exemplary database information description 1600 that is displayed when database button 1404 is selected. Database information description 1600 includes selectable buttons for a database type 1602, a database name 1604, a database description 1606, a keyword list 1608, a schema 1610, and queries 1612.

### Select Database Type

FIG. 17 shows one exemplary list 1700 of supported database types that is displayed when Database Type button 1602 is selected. List 1700 shows supported database types and a schema flag that indicated whether each of the database types has a schema. The developer selects one of the supported database types, wherein system 100 is automatically configured to accept queries or commands for that database type.

### Schema

Where the schema flag indicates “no”, a schema is not available for that database type, and the Schema button is gray and is not selectable. When the schema flag indicates “yes”, the schema button is selectable. FIG. 18 shows one exemplary schema 1800 created by the developer by selecting the schema button to define the current database. Schemas may be used by associator 108 to identify potential databases for associating code blocks with a particular element of software design 110.

The first time a table is defined it is placed into the selected database using the SQL CREATE TABLE for SQL databases or a similar command for NoSQL databases. Adding data to an existing database table is performed using the SQL UPDATE (for SQL databases) or similar command for NoSQL databases to be generated. The SQL schema may be changed using ALTER, DROP, DELETE, or TRUNCATE commands for SQL databases or similar commands for NoSQL databases.

### Queries

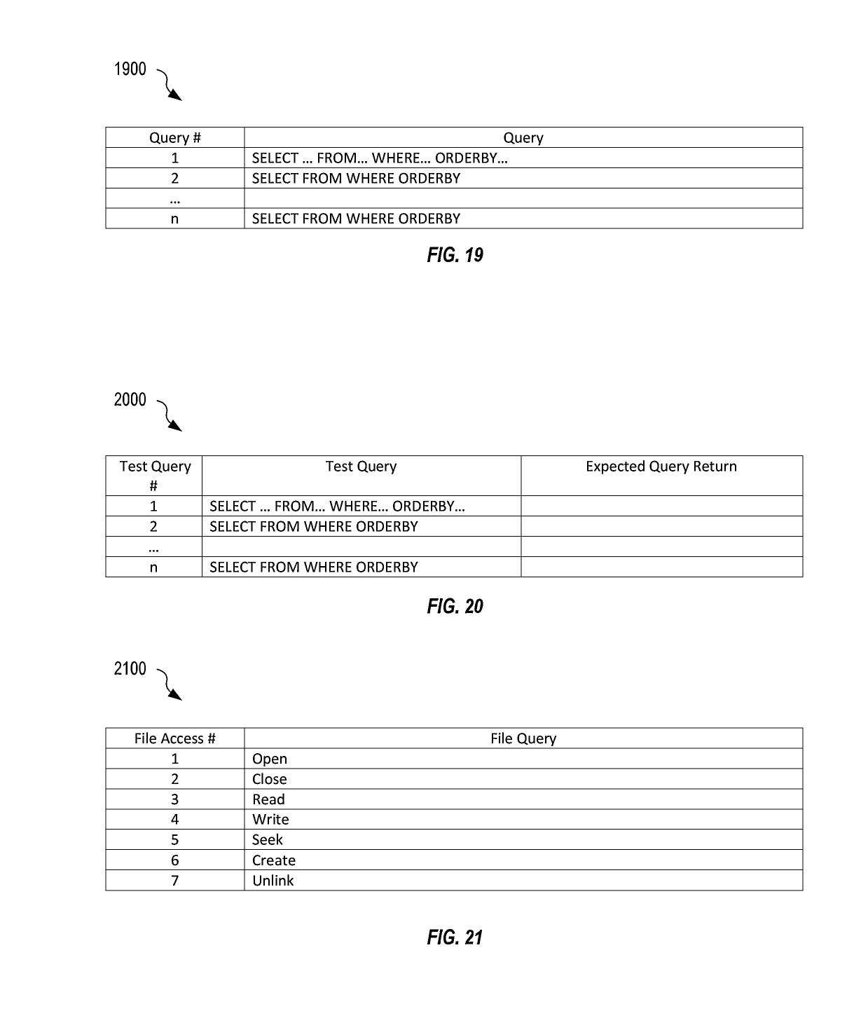

FIG. 19 shows one exemplary query entry screen 1900 that is displayed when the developer selects queries button 1612 of database information description 1600. Query entry screen 1900 allows the developer to enter one or more queries for accessing the current database. Each query may be accessed from software design 110 by selection of the query number corresponding to the required query. This query is submitted to the database as a dataflow, and the return value from the database is returned as a return data flow within the software design. Queries may be used by associator 108 to identify potential databases for associating code blocks with a particular element of software design 110.

The first time data is placed into the selected database, a CREATE TABLE (for SQL databases) or similar command for NoSQL databases is generated. Adding data to an existing database generates an UPDATE (for SQL databases) or similar command for NoSQL databases. Changing schema 1800 causes an ALTER command to be generated for SQL databases or similar command for NoSQL databases.

FIG. 20 shows one exemplary screen 2000 for defining a set of test queries that is attached to a database to allow that database to be tested for correctness. FIG. 21 shows one exemplary screen 2100 for defining file “queries”.

### Automatic Attachment of Databases to Design Element

Since a file or a database may exist outside of a program, it is very useful to be able to locate the proper file or database. For use herein, the term “exist outside of a program” is used to define a file or database located outside of a software design 110 within the development environment 100. Considering that the file format (for flat files) and schemas (for SQL databases) and keys (for key-value type NoSQL databases) all define how to access the data, these data access methods may be used to find the correct file or database. First determine if the keyword search will be against files or databases and if against databases whether the database is SQL or NoSQL. Second use the keyword search to create a list of potential file/databases.

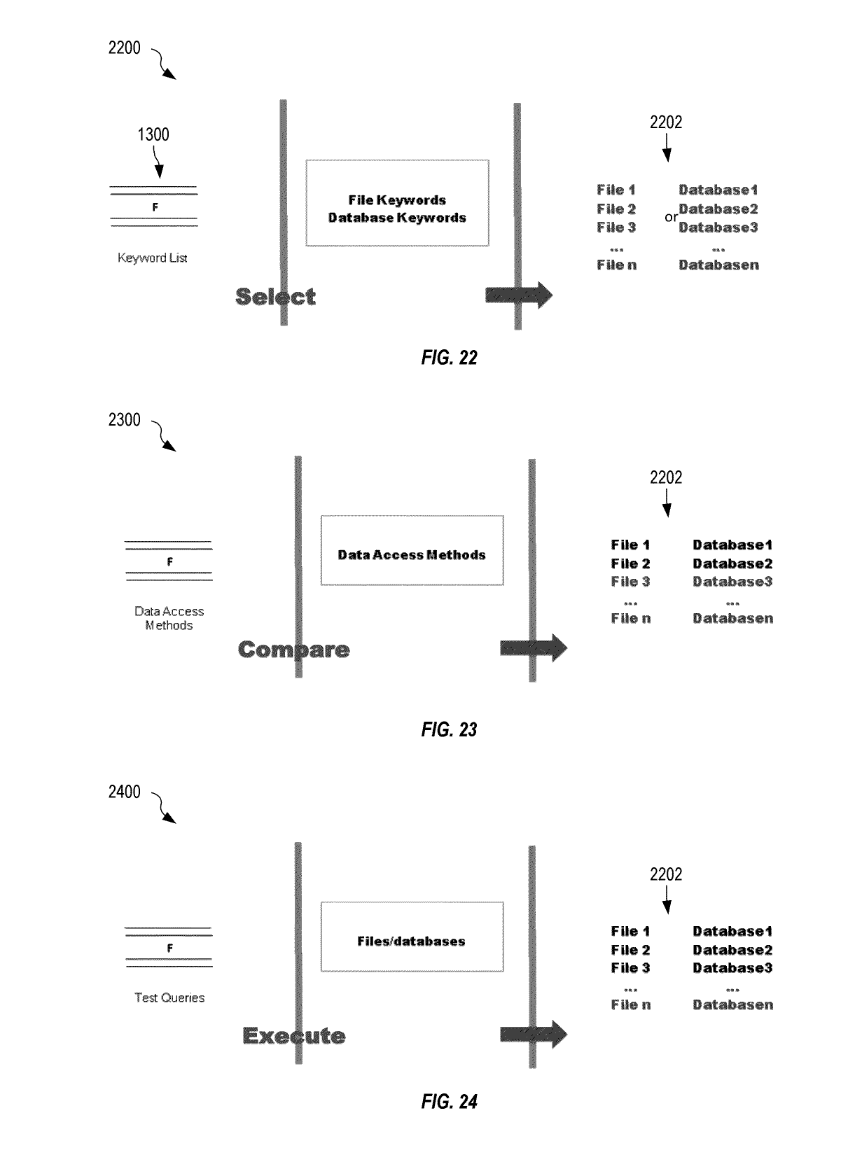

FIG. 22 shows a first step 2200 of generating a file or database list 2202 based upon keywords of the F-type data store identified by the developer selecting F-type data store symbol 1300 within software design 110.

FIG. 23 shows one exemplary second step 2300 for culling file or database list 2202 by comparing the F-Type Data Access Method and the defined Data Access Methods of each file or database. Where the data access methods of the listed file/databases does not match the data access method defined by the F-type data store, the file/database is removed from list 2202.

FIG. 24 shows a third step 2400 for further culling list 2202 by executing test queries defined using screen 2000 and attached to a database against each remaining files/databases within list 2202. If the expected query return values are incorrect then those files/databases are culled from list 2202.

If more than one file/database remains within list 2202 then the one file/database in the list that best meets the goals defined by the developer using table 900 of FIG. 9 is selected.

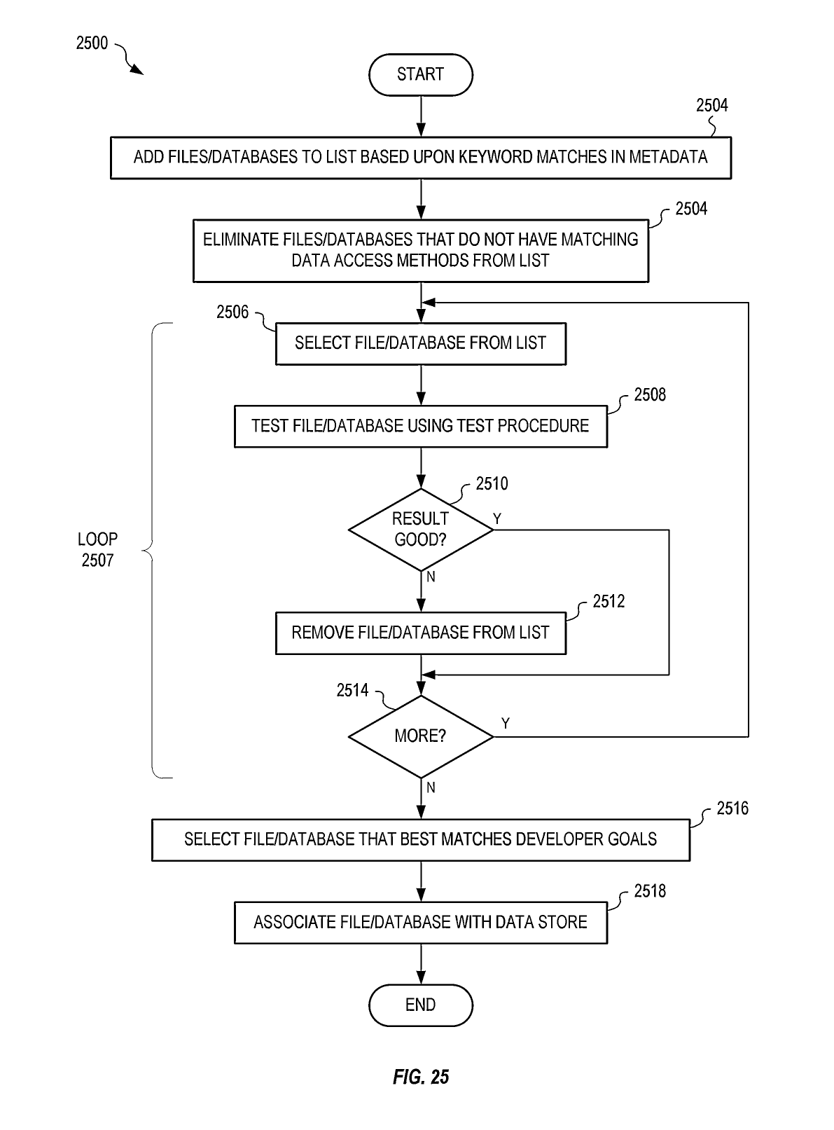

FIG. 25 is a flowchart illustrating one exemplary method 2500 for automatically associating a file/database with a design element of a software design. Method 2500 is for example implemented as machine readable instructions that form at least part of associator 108 of development server 101, FIG. 1.

In step 2502, method 2500 adds files/databases to a list based upon keyword matched in metadata. In one example of step 2502, associator 108 compares keywords of metadata 1218 of each file/database 1216 with keywords of metadata 1214 of data store 1212 and adds file/database 1216 to list 1209 if the keywords match.

In step 2504, method 2500 eliminates files/databases that do not have matching access methods from the list. In one example of step 2504, associator 108 compares, for each file/database 1216 within list 1209, access method 1217 with access method 1213 of data store 1212, and removes file/database 1216 from list 1209 where access method 1217 does not match access method 1213.

Steps 2506 through 2514 form a loop 2507 that repeats for each file/database 1216 within list 1209. In step 2506, method 2500 selects a first, and subsequently a next, file/database from the list. In one example of step 2506, associator 108 selects a next file/database 1216 from list 109. In step 2508, method 2500 tests the file/database using a test query of the data store. In one example of step 2508, associator 108 uses test query 1230 to test file/database 1216 selected in step 2506.

Step 2510 is a decision. If, in step 2510, method 2500 determines that the test results are correct, method 2500 continues with step 2514; otherwise method 2500 continues with step 2512. In step 2512, method 2500 removes the file/database from the list. In one example of step 2512, associator 108 removes file/database 1216 from list 1209.

Step 2514 is a decision. If, in step 2514, method 2500 determines that at least one unprocessed file/database is within the list, method 2500 continues with step 2506 to repeat loop 2507; otherwise method 2500 continues with step 2516.

In step 2516, method 2500 selects a file/database from the list that best matches developer goals. In one example of step 2516, associator 108 evaluates each remaining file/database 1216 within list 1209 and selects the file/database that matches design goals 111.

In step 2518, method 2500 associates the file/database with the data store. In one example of step 2518, associator 108 associates file/database 1216 with data store 1212. Data store 1212 may then be used by associator 108 for identifying code blocks within data store 1212 that match element 112.

Automatic Gantt Chart Creation:

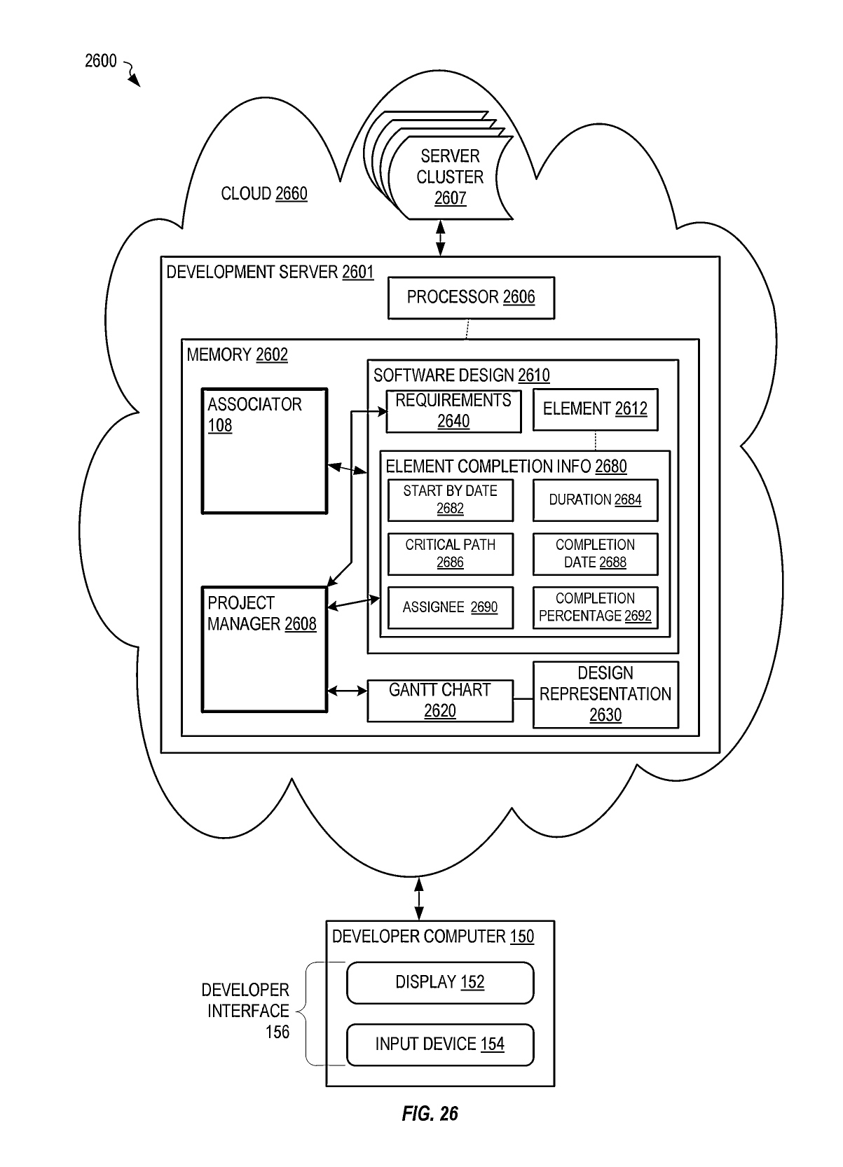

FIG. 26 shows an exemplary parallel processing development system 2600 for automatic Gantt chart creation, in one embodiment. System 2600 is similar to system 100, and includes development server 2601 that is located within cloud 2660 (e.g., a computer network accessible via the Internet) and is coupled with, or is a part of, a server cluster 2607. Each of cloud 2660 and server cluster 2607 are similar, and therefore include the same attributes as discussed above with respect to could 160 and server cluster 107, respectively, of FIG. 1. Development server 2601 is a computer with a processor 2106 and a memory 2602 that stores a software design 2610. Memory 2602 is also shown storing a project manager 2608 formed of machine readable instructions that when executed by processor 2606 implement functionality of system 2600 as described below.

Software design 2610 is similar to software design 110, of FIG. 1, and contains at least one element 2612 that has associated completion information 2680, including element start by dates 2682, element duration 2684, project critical path indicator 2686, element completion date 2688, element assignee information 2690, and element completion percentage 2692—each of which is described in further detail below. Software design 2610 is for example a hierarchical functional decomposition software design as disclosed in U.S. application Ser. No. 13/425,136 (e.g. decomposition of algorithm 117 within application 13/425,136).

Completion information 2680 is manually entered by a developer, using developer computer 150, or automatically generated by project manager 2608. Project manager 2608 then utilizes such information to automatically generate a project Gantt chart 2620. Project Gantt chart 2620 is then used in conjunction with design representation 2622 which is a visual representation of software design 2610 including completion information 2680. Each of Gantt chart 2620 and design representation 2622 may be displayed on display 152 of developer computer 150. Moreover, a developer may interact with each of Gantt chart 2620 and design representation 2622 using input device 154 and interface 156 of developer computer 150.

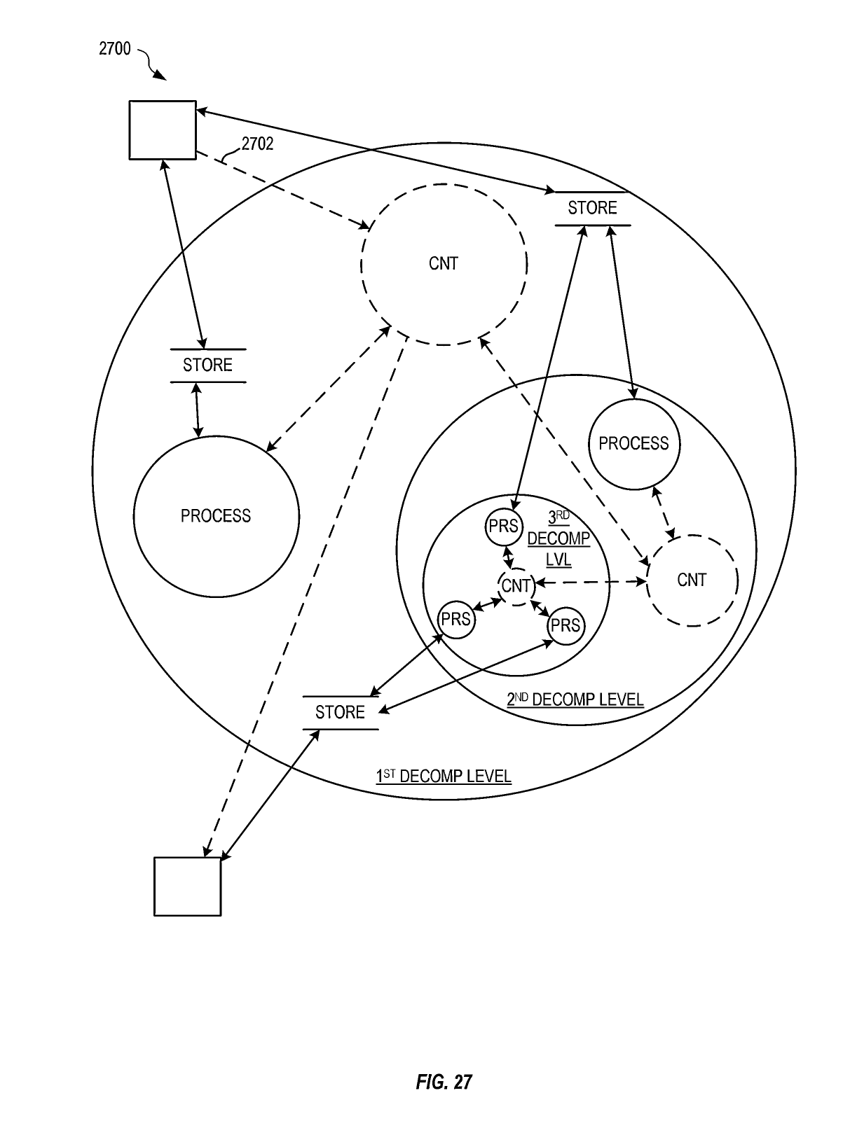

FIG. 27 depicts an exemplary hierarchical software design 2700, in one embodiment. Design 2700 is for example a depiction of software design 2610, of FIG. 2600. Within design 2700, dashed lines represent control flows, solid lines represent data flows, dashed circles represent control transforms, solid circles represent process transforms, parallel lines represent data stores, and square represent terminators.

Within design 2700, where a process is equated to a task to be performed, then each decomposition level may represent a group of linked tasks. Within a given decomposition level, processes are linked together using control flows attached to the central control process. A control flow is specifies when some process is to be called. The control flow contains three types of conditional statements: “init”, “if”, and “call-after” or some combination of “if” and “call-after”. The “init” conditional statement represents the beginning of a series of processes. For example, an “init” condition is illustrated by control flow 2602. With regards to project management, the first series of processes must have a start-by date and duration. Where a control flow attached to a process does not contain either an “init” or a “call-after” conditional statement then it is considered the beginning of a series of processes. A series can be one or more processes linked together. The “call after” conditional statement represents a sequence of activity: the current process is called after some other process has completed.

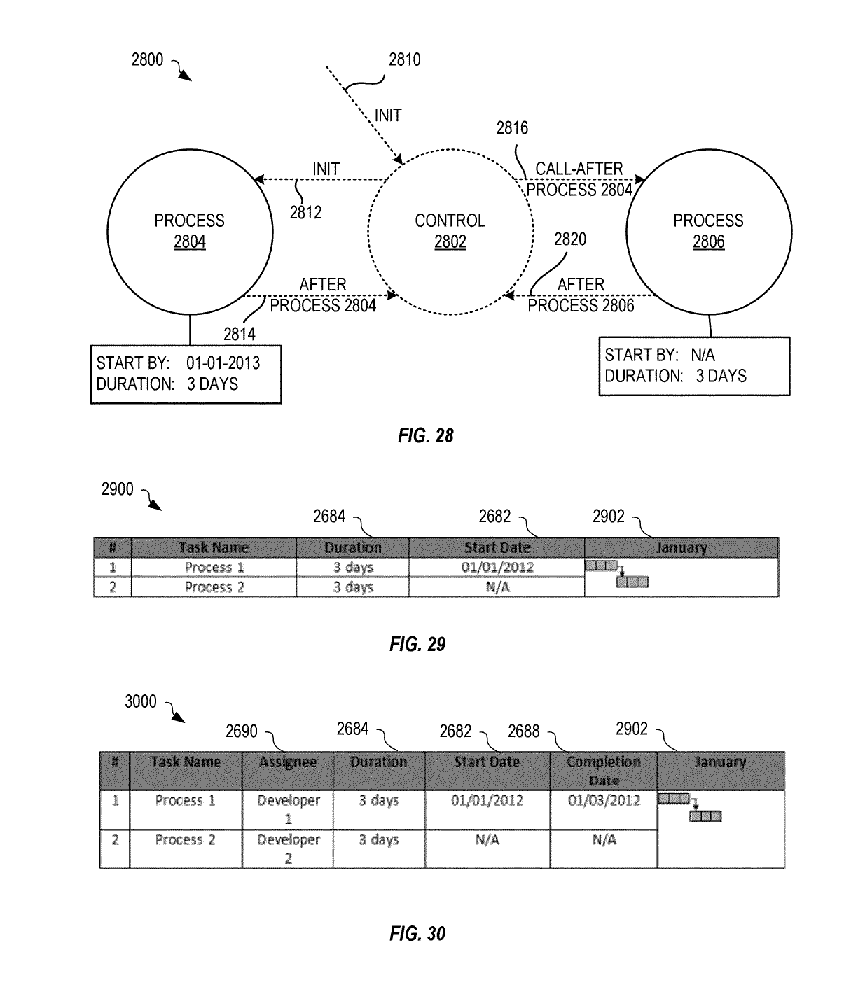

Each process, or decomposition level, defines an individual element 2612 within design 2610. Project manager 2608 automatically generates completion information 2680 for each element 2612. FIG. 28 depicts an exemplary two process design 2800 showing conditional statements, and completion information thereof. Design 2800 is an example of design 2610 includes a control transform 2802, a first process 2804, and a second process 2806. Each of first process 804 and second process 2806 is shown including completion information 2820, 2822, respectively, generated by project manager 2608 of FIG. 26. Flow within the design 2800 is as follows. Control flow 2810 is an init statement that initializes control transformation 2802. Control transformation 2802 then executes control flow 2812 to initialize process 2804. After process 2804 is executed, control flow 2814 executes to return to control transform 2802 which then executes control flow 2816 to execute process 2806. After process 2806, control flow 2818 executes to return to control transform 2802. With regards to project management, design 2800 would not be complete until development of each of process 2804 and 2806 are completed by a developer, or automatically using associator 108.

Within completion information 2680, the start by date 2682, and duration 2684 may be manually entered by a developer by using input device 154 and right-clicking on the process of interest within design representation 2630 when displayed on display 152. Where a particular process includes a call-after in its conditional statement, such as process 2806 within design 2800, project manager 2808 automatically generates the start date as “n/a”.

FIG. 29 depicts an exemplary Gantt chart 2900, of process 2800 of FIG. 28, created by project manager 2608 of FIG. 26, in one embodiment. Gantt chart 2900 is a visual representation, such as a table, of completion information 2680. For example, Gantt chart 2900 includes the task name, duration 2684, start date 2682, and graphical date information 2902 for each of process 2804 and 2806 of FIG. 2800.

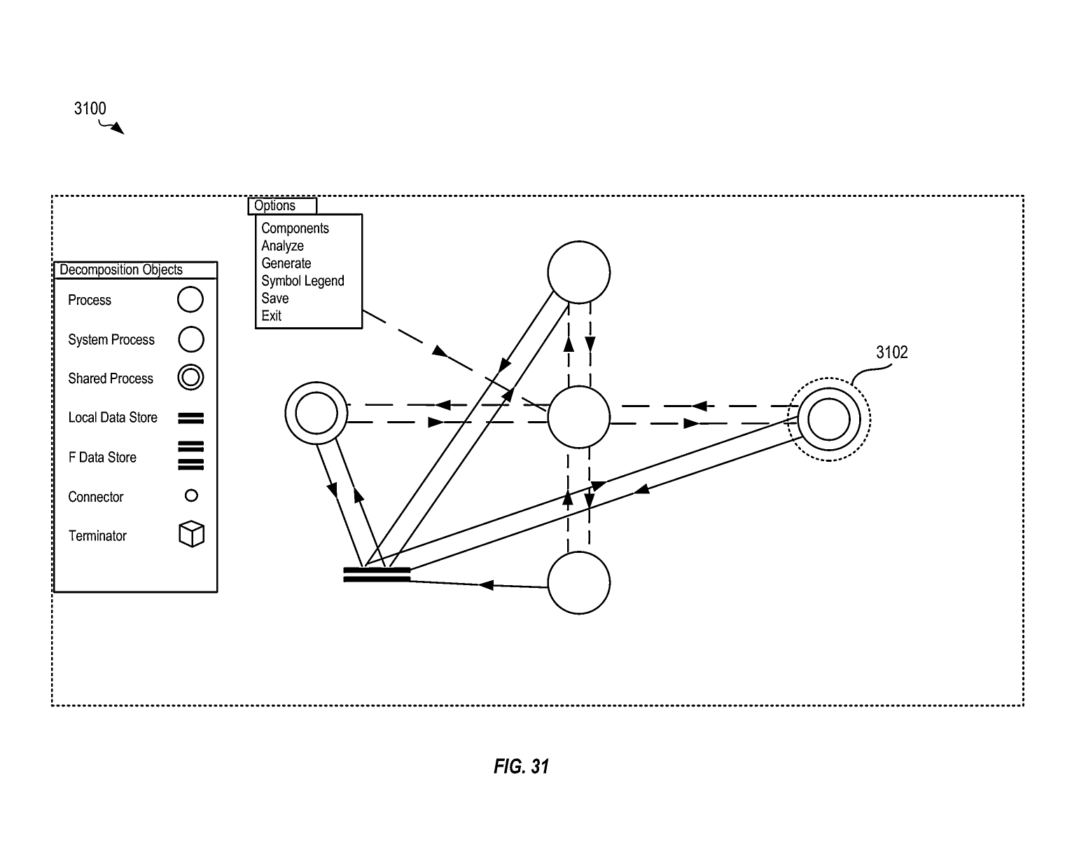

FIG. 30 depicts Gantt chart 3000, that is similar to Gantt chart 2900, of FIG. 29, but further includes assignee 2690 information. Gantt chart 3000 further includes completion date 2688. Project manager 2608 may automatically generate completion date 2688, or such information may be manually entered by a developer. Additionally, project manager 2608 may cooperate with associator 108, or include the functionality of associator 108, to automatically attach code blocks to each element 2612. Accordingly, where a code block is automatically attached, the completion date may automatically be generated and stored within memory 2602 based on the date of association.

Where an element within design 2610 cannot be automatically associated, project manager 2608 may automatically determine the most critical element of design 2610 that needs to be developed. FIG. 31 depicts an exemplary screen shot of visual representation 3100 including a critical path indicator 3102, in one embodiment. Visual representation is an example of visual representation 2630 of FIG. 26. Visual indicator 3102 indicates which element 2612 is identified as a critical path 2688 by project manager 2608. Visual representation 3100 may include more visual indicators for each element of the design that was not automatically associated with a code block by associator 108 or project manager 2608 utilizing the above functionality discussed above with respect to associator 108.

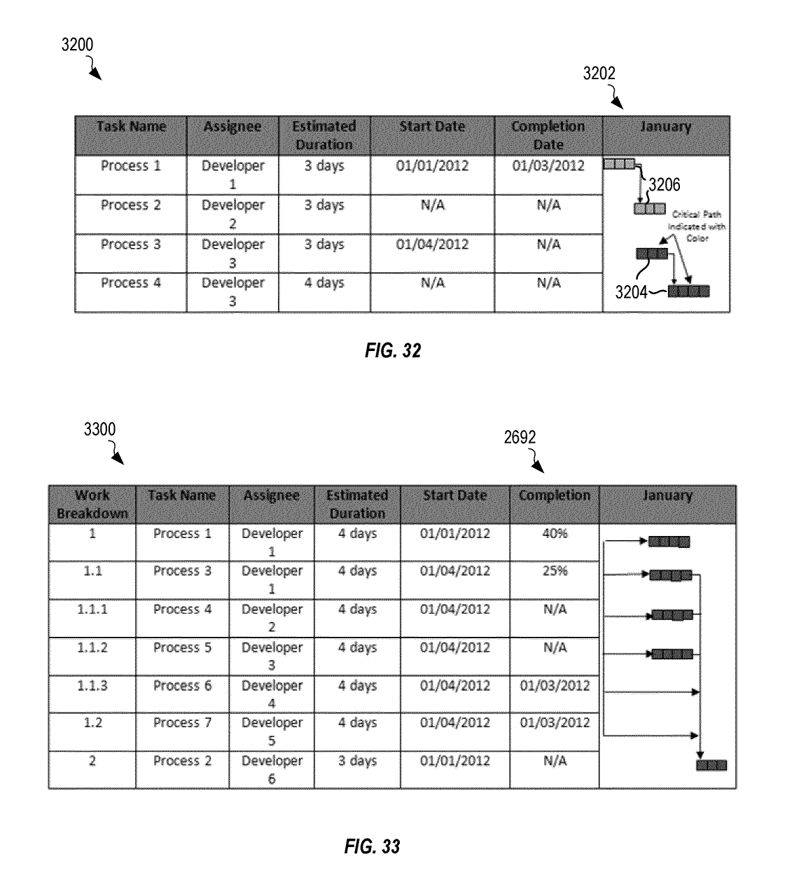

Critical path may additionally be illustrated on the Gantt chart 2620. For example, FIG. 32 depicts a visual representation 3200 of Gantt chart 2620 of FIG. 26 further illustrating a critical path. Visual representation 3200 is similar to Gantt chart 3000, but further includes critical path indicator 3202. Critical path indicator 3202 is generated by project manager 2608 and is shown as a different color or pattern than the indicator 3206 of finished elements (i.e. elements that were automatically associated with a code block or have already been developed by a developer.)

Project manager 2608 may further calculate the completion percentage 2692 of a given software design 2610. Completion percentage 2692 be displayed via the Gantt chart 2620. FIG. 33 depicts an exemplary Gantt chart 3300 including completion percentage data 2692. As seen in FIG. 27, a design 2610 may include a plurality of decomposition levels. Thus, a process may decompose. If a process decomposes, it includes multiple lower-level processes. If all of the multiple lower level-processes have a code block associated therewith (via automatic association by associator 108, or by development by a developer) then the upper level process is 100% complete. For example, within FIG. 33, process 1 includes five lower-level processes 1.1, 1.1.1, 1.1.2, 1.1.3, and 1.2. As illustrated, processes 1.1.3 and 1.2 were completed on Jan. 3, 2012. Therefore, upper level process 1 is forty percent complete. Parallel start times are detected by the fact that different developers are assigned with different lower-level processes within a common upper-level process.

Project manager 2608 may further automatically estimate the completion date of the entire design 2610. Referring back to FIG. 26, a software design 2610 may further include a list of associated requirements 2640 that must be met by software design 2610. Requirements 2640 may be set by a developer or project administrator. During development of design 2610, more elements 2612 may be added and associated with requirements 2640. Project manager 2608 may estimate the total number of elements that will be required for completion of development of design 2610. The total number of estimated elements is the average number of elements per requirements with at least one associated element times the number of requirements.

Moreover, project manager 2608 may then estimate the percentage of the project that is completed based upon the completed elements divided by the estimated number of required elements. Completed elements may be identified by those elements having a completion percentage of 100% within completion data 2692.

Further yet, project manager 2608 may identify the estimated time it will take to complete a project. The time to complete a project is estimated by the average duration per completed element times the average number of developers per element times the estimated number of processes minus the elapsed time. Average duration per completed element is based upon duration 2684. Average number of developers per element is based upon assignee information 2690.

The estimated completion date, estimated time to complete a project, and the estimated percentage complete may all be indicated on Gantt chart 2620 and/or design representation 2630.

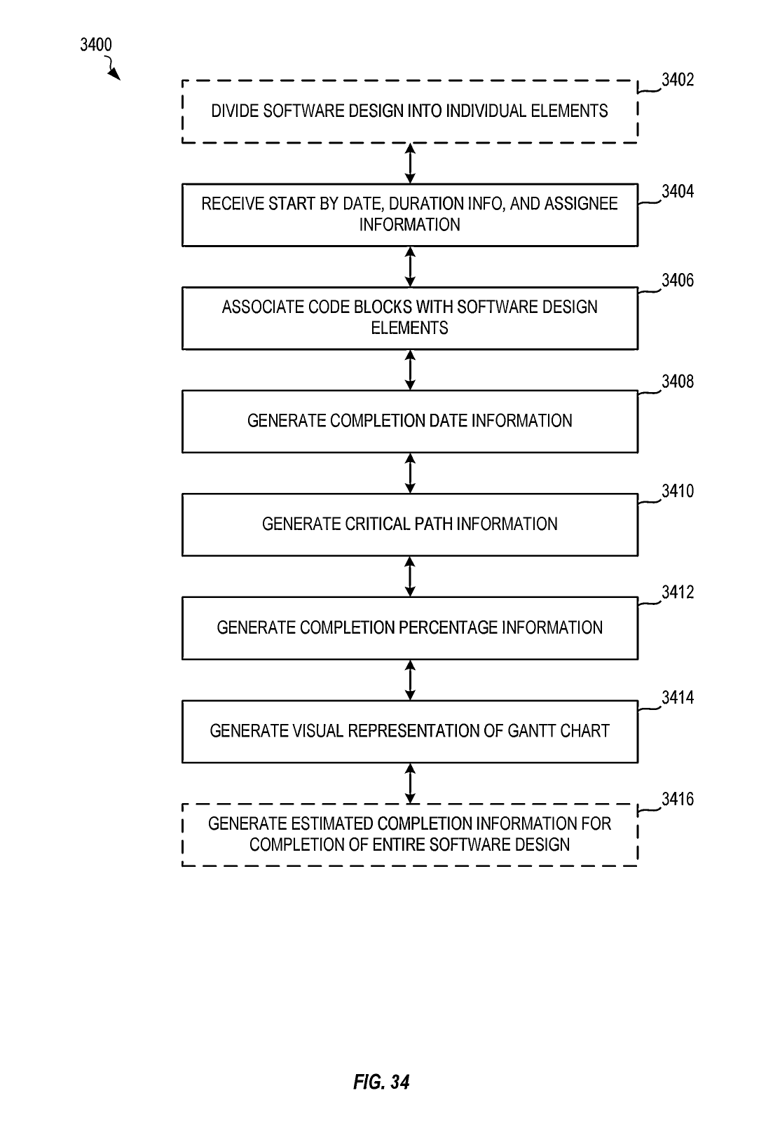

FIG. 34 depicts a method 3400 for automatic Gantt chart creation, in one embodiment. Method 3400 is implemented using system 2600, for example.

In optional step 3402, method 3400 divides a software design into individual elements. In one example of optional step 3402, project manager 2608, or associator 108, divides software design 2610 into a plurality of individual elements 2612. Elements 2612 may form a hierarchical software design. Alternatively, in one example of step 3402, software design 2610 is manually divided into a plurality of elements 2612 by a developer or administrator.

In step 3404, method 3400 receives completion information from a developer. In one example of operation of step 3404, program manager 2608 receives completion information 2680 including start by date 2682, duration 2684, and assignee information 2690 from a developer using developer computer 150.

In step 3406, method 3400 associates code blocks with software design elements. In one example of step 3406, program manager 2608 cooperates with associator 108 to automatically associate code blocks 116 with elements 112 (i.e. elements 2612). In another embodiment, program manager 2608 includes the functionality to automatically associate code blocks with each element 2612. In another embodiment, a developer develops code blocks for each element 2612. It should be appreciated that not all elements 2612 need to be associated or developed at the same time.

In step 3408, method 3400 generates completion date information for each completed element. In one example of step 3408, method 3400 automatically generates completion date 2688 based upon the date of automatic association via associator 108. In an additional example of step 3408, project manager 2608 receives the completion date from a developer using developer computer 150. Project manager 2608 then stores the received completion date as completion date 2688 in memory 2602.

In step 3410, method 3400 generates critical path information. In one example of step 3410, project manager 2608 generates critical path information 2686 for each element 2612 that does not have a code block associated therewith. Project manager 2608 may further prioritize completion of each unassociated element based upon any the critical path information 2686.

In step 3412, method 3400 generates completion percentage information. In one example of step 3412, project manager 2608 generates completion percentage information 2692 based upon the number of elements associated with a code block compared to the number of unassociated elements.

In step 3414, method 3400 generates a visual representation of a Gantt chart. In one example of step 3414, project manager 2608 generates Gantt chart 2620 and/or design representation 2630 including element completion information 2680 therein.

In step 3416, method 3400 generates estimated completion information of the entire software design. In one example of operation, project manager 2608 determines the estimated total number of required elements that will be required for completion of development of design 2610 based upon the average number of elements per requirements with at least one associated element multiplied by the number of requirements 2640. Project manager 2608 may then estimate the percentage of completion based upon the completed elements divided by the estimated number of required elements. Project manager 2608 may then identify the estimated time to complete software design 2610 based upon the average duration per completed element multiplied by the average number of developers per element multiplied by the estimated number of elements minus the elapsed time.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for automatically associating a software code block with a design element of a software design, comprising:
a processor;
a memory communicatively coupled with the processor storing:
the software design having the design element, the design element having (i) a list of keywords and (ii) test procedures associated therewith; and
an associator stored within the memory as non-transitory computer readable instructions that when executed by the processor associate the software code block with the design element.

2. The system of claim 1, the associator comprising instructions for:
identifying potential code blocks having metadata that matches at least a portion of the keywords,
testing potential code blocks with test procedures associated with the design element,
associating a matching code block, of the potential code blocks, having correct results from the testing with the software design.

3. The system of claim 2, the memory further storing developer goals associated with the software design; wherein the associator further comprises instructions for generating the matching code block based upon the developer goals.

4. The system of claim 1, the test procedures comprising input data and expected output data, wherein the associator identifies matching code blocks by executing the potential code block with the input data and determining whether the potential code block generates the expected output data.

5. The system of claim 1, further comprising a data store of potential code blocks having associated data store metadata.

6. The system of claim 5, wherein the associator identifies potential databases having associated database metadata for association with the data store based upon match of the database metadata to the data store metadata.

7. The system of claim 5, the data store metadata including access methods defining requirements for accessing the particular database, and wherein the associator determines whether the design element matches the access requirements.

8. The system of claim 5, wherein the associator identifies potential data stores based upon analysis of data stores against developer defined data store test queries.

9. The system of claim 5, wherein the associator identifies potential data stores based upon analysis of data stores against developer goals.

10. A method for automatic Gantt chart creation of a software design having a plurality of elements, comprising:
receiving, at a project manager comprising non-transitory computer readable medium stored on memory communicatively coupled to a processor of a software development system, completion information of the elements of the software design;
generating completion date information based upon a date that code blocks are assigned to each of the elements; and
generating a visual representation of a Gantt chart including the completion information and the completion date information.

11. The method of claim 10, further comprising automatically associating the code blocks with the elements; wherein generating completion date information includes automatically assigning a completion date to each element based upon the date that the code blocks were automatically associated with the elements.

12. The method of claim 10, further comprising dividing the software design into a plurality of individual elements.

13. The method of claim 10, the step of receiving completion information comprising receiving start-by date, duration information, and assignee information for each element.

14. The method of claim 10 further comprising generating critical path information for each element that does not have a code block associated thereto.

15. The method of claim 10 further comprising generating completion percentage information for each element.

16. The method of claim 10, the step of generating a visual representation of the Gantt chart comprising sending the Gantt chart to a developer computer for display thereon.

17. The method of claim 10, further comprising generating estimated completion information for the overall software design.

18. The method of claim 17, the step of generating estimated completion information comprising determining the estimated total number of required elements for the overall software design, estimating the percentage of completion of the overall software design, and identifying the estimated time to complete development of the overall software design.

19. The method of claim 18, the estimated total number of required elements is based upon an average number of elements per requirement of the software design, having at least one element associated thereto, multiplied by the number of requirements.

20. The method of claim 18, wherein the percentage of completion of the overall software design is based upon the number of completed elements having a code block associated thereto divided by the estimated total number of required elements.

21. The method of claim 18, wherein the estimated time to complete the overall software design is based upon the average duration per completed element having a code block associated thereto multiplied by the average number of developers per completed element multiplied by the estimated total number of required elements minus the elapsed time since start of development of the overall software design.
